(19) United States
(12) Patent Application Publication
(10) Pub. No.: US 2008/0133245 A1
(43) Pub. Date: Jun. 5, 2008

(54) Methods for speech-to-speech translation

(75) Inventors: Guillaume Proulx, Cupertino, CA (US); Youssef Billawala, Campbell, CA (US); Elaine Drom, Sunnyvale, CA (US); Farzad Ehsani, Sunnyvale, CA (US); Yookyung Kim, Los Altos, CA (US); Demitrios Master, Cupertino, CA (US)

Correspondence Address: EMIL CHANG;LAW OFFICES OF EMIL CHANG, 874 JASMINE DRIVE, SUNNYDALE, CA, 94086, US

(73) Assignee: Sehda, Inc.

(21) Appl. No.: 11/633,859

(22) Filed: Dec. 4, 2006

(51) Int. Cl. G10L 21/00; G06F 17/28; G10L 11/00

(52) U.S. Cl. 704/277; 704/5; 704/E11.001; 704/E21.001

(57) ABSTRACT

The present invention disclose modular speech-to-speech translation systems and methods that provide adaptable platforms to enable verbal communication between speakers of different languages within the context of specific domains. The components of the preferred embodiments of the present invention includes: (1) speech recognition; (2) machine translation; (3) N-best merging module; (4) verification; and (5) text-to-speech. Characteristics of the speech recognition module here are that the modules are structured to provide N-best selections and multi-stream processing, where multiple speech recognition engines may be active at any one time. The N-best lists from the one or more speech recognition engines may be handled either separately or collectively to improve both recognition and translation results. A merge module is responsible for integrating the N-best outputs of the translation engines along with confidence/translation scores to create a ranked list or recognition-translation pairs.

### FIELD OF THE INVENTION

The present invention relates to methods for translation, and in particular, methods for speech-to-speech translation.

### BACKGROUND

An automatic speech-to-speech (S2S) translator is an electronic interpreter that enables two or more people who speak different natural languages to communicate with each other.

The translator may comprise of a computer, which has a graphical and/or verbal interface; one or more audio input devices to detect input speech signals, such as a receiver or microphone; and one or more audio output devices such as a speaker. The core of the translator is the software, which may have three components: a speech recognizer, a machine translation engine, and a text-to-speech processor.

Automatic speech recognition (ASR) is defined as the conversion of an input speech signal into text. The text may be a “one-best” recognition, an “N-best” recognition, or a word-recognition lattice, with their associated recognition confidences. The broader the domain that an ASR engine is trained to recognize, the worse the recognition becomes. This balance between recognition coverage and precision is a recurring theme in the field of S2S translation and is fundamental to the assessment of each component's performance. Note that the word “engine” used herein may be the same engine but with different domains.

Automatic machine translation (MT) is the task of translating text in one natural language to another. Machine translation is generally performed by methods in one or more of the following categories: rule-based machine translation (RBMT), example-based machine translation (EBMT), and statistical machine translation (SMT).

RBMT is a knowledge-based approach wherein grammatical templates are generated either manually or semi-automatically. A template is applied to the input text and translated via a translation grammar. The advantage of this method is that there is no requirement for large amounts of training data (i.e. in the form of parallel and/or monolingual corpora). This method, however, does require human expertise to create these grammars and is therefore “expensive” and susceptible to low recall or conversely low precision of translation.

Corpus-based EBMT is translation by analogy, meaning the system uses instances of parallel text on which the system is trained to translate a new instance of the text. The main drawback to the EBMT approach is that the coverage is directly proportional to the amount of training parallel data and therefore generally very low except in very narrow-domain situations.

At the heart of SMT lies learning translation statistically from a sentence aligned parallel corpus. From the parallel corpus, SMT systems learn several models such as lexicon, distortion, and fertility. SMT can be further broken down into word-based (Brown et al. 1990) and phrase-based approaches (Och et al. 1999), depending on the unit of translation. A phrase-based approach can handle local word order or idiomatic expressions better than a word-based approach, but is still limited in handling global word order.

A text-to-speech (TTS) processor handles how a translated text is converted into sound. Systems are trained on recorded speech in the target language. Phone or word sequences are sampled and stitched together to derive the output signal.

S2S systems are subject to propagation of error. The quality of the input signal affects the quality of the speech recognition. Similarly, the quality of the recognized text directly affects the quality of the MT and thereby also the output of the system via a TTS processor. Additionally, each component contributes its own error. A robust S2S system is able to minimize these errors and improve the output of any one component by applying constraints from the succeeding component thereby rendering the system robust to that error.

Each of the methods described above has its strengths and weaknesses and it would be desirable to have a system that would incorporate and integrate the strengths of certain methods while minimizing their weaknesses.

### SUMMARY OF INVENTION

An object of the present invention is to provide translation systems and methods that provide adaptable platforms to enable verbal communication between speakers of different languages within the context of specific domains.

Yet another object of the present invention is to provide translation systems and methods that provide better speech recognition and better translation accuracy.

Still yet another object of the present invention is to provide translation systems and methods that provide rapid implementation of translation systems that can be easily tuned for speech domains.

Briefly, the preferred embodiments of the present invention disclose modular speech-to-speech translation systems and methods that provide adaptable platforms to enable verbal communication between speakers of different languages within the context of specific domains. The components of the preferred embodiments of the present invention includes: (1) speech recognition; (2) machine translation; (3) N-best merging module; (4) verification; and (5) text-to-speech.

An advantage of the present invention is that it provides translation systems and methods that provide adaptable platforms to enable verbal communication between speakers of different languages within the context of specific domains.

Yet another advantage of the present invention is that it provides translation systems and methods that provide better speech recognition and better translation accuracy.

Still yet another advantage of the present invention is that it provides translation systems and methods that provide rapid implementation of translation systems that can be easily tuned for speech domains.

### DESCRIPTION OF THE DRAWINGS

The foregoing and other objects, aspects and advantages of the invention will be better understood from the following detailed description of preferred embodiments of this invention when taken in conjunction with the accompanying drawings in which:

FIG. 1 is an illustration of a preferred embodiment of the present invention, the S-MINDS S2S system.

FIG. 2 is an illustration of the components of the preferred embodiment of the present invention, illustrating ASR+MT+Merge+Verification+TTS components of S-MINDS.

FIG. 3 illustrates a flowchart of the verification module.

FIGS. 4a and 4b provide an example of multi-stream recognition, where recognition of answers to the question: “Have you had any illnesses in the past year?”.

FIG. 5 illustrates an example of the hierarchical ontology of questions in the domain of doctor-patient interaction.

FIG. 6 illustrates examples of rule-based recognition/translation approaches.

### DETAILED DESCRIPTION OF THE PREFERRED EMBODIMENTS

The presently preferred embodiments of the present invention (also referred to as “S-MINDS”) disclose modular S2S translation systems that provide adaptable platforms to enable verbal communication between speakers of different languages within the context of specific domains. Along with a grammar development tool, the present invention provides a platform to enable the rapid development of translation systems, where these systems provide long-term S2S translation solutions with ease.

Two characteristics of the speech recognition module here are that the modules have been structured to provide N-best selections and multi-stream processing. Fundamentally, the minimum requirement for the speech recognition modules (or commonly referred to as ASR) is that it interprets an input signal into a string of text (equaling to 1^{st} best). Generally, ASR systems output not only the highest-confidence recognition but also lower-confidence results along with confidence scores. In the preferred embodiments of the present invention, with structured N-best or lattice output, the result can be further processed to achieve better recognition or processed in conjunction with the translation modules to also achieve better translation accuracy.

The preferred embodiments of the present invention employ a multi-stream approach to ASR wherein multiple speech recognition engines may be active at any one time. The advantage of allowing multiple engines is that strengths of different domain sizes or types can be leveraged. The N-best lists from the one or more speech recognition engines may be handled either separately or collectively to improve both recognition and translation results.

Machine translation is performed via a hybrid translation module, which allows for multiple types of translation engines such as knowledge-based and statistical-based translation engines. The translation module is able to process a one-best output of the ASR module up to the full word lattice with associated confidence value output to arrive at the best recognition-translation pair for each translation engine. The merge module is responsible for integrating the N-best outputs of the translation engines along with confidence/translation scores to create a ranked list or recognition-translation pairs. The preferred embodiments of the present invention give the option to put the human into the recognition loop thru either verbal or visual screen-based verification of recognized input.

The present invention can operate in 1-way, 1.5-way or full 2-way mode. In 1-way mode the system is simply acting as a translator of one person's speech. In 1.5-way mode (or interviewer-driven mode), the interviewer initiates the dialog by asking questions and making statements; the interviewee may only respond but not initiate dialog himself In full 2-way mode the system has general S2S translation with no restrictions beyond the limits of the domain on which the system is trained.

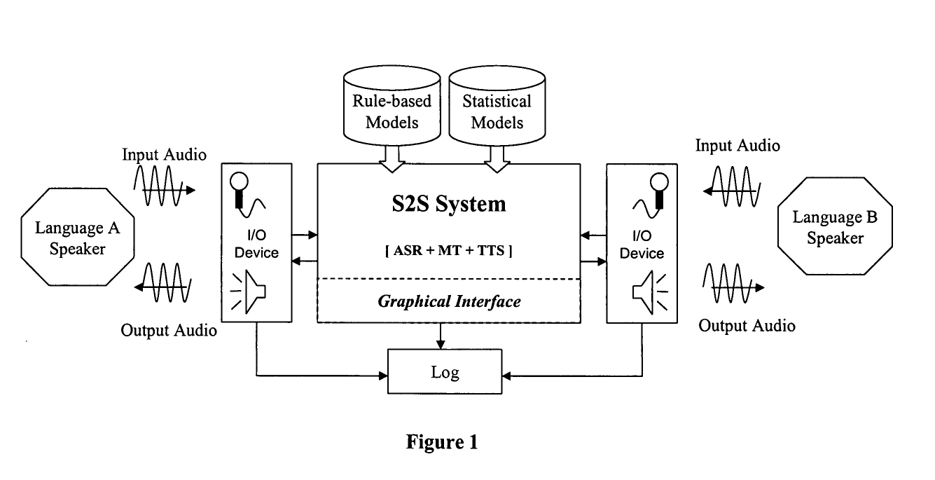

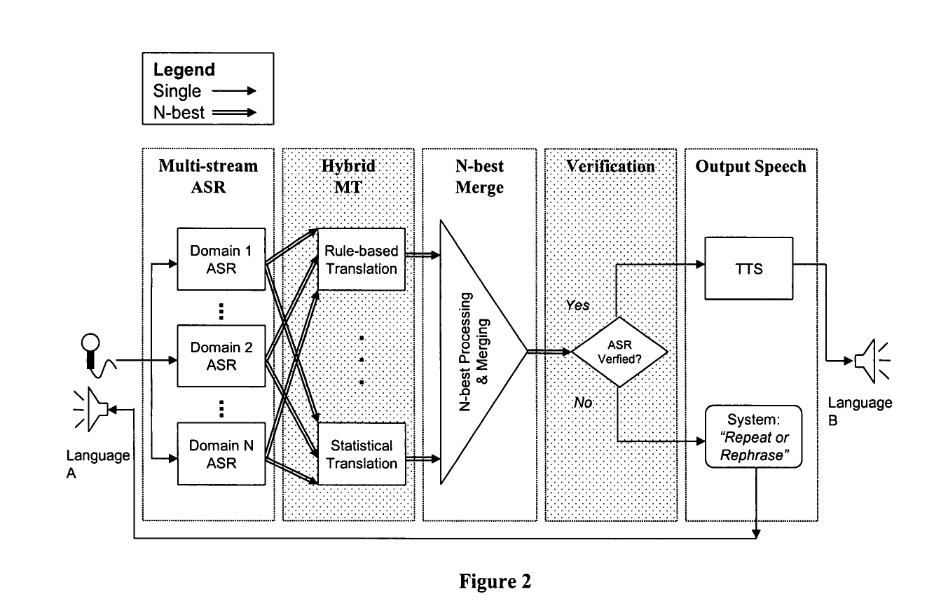

Referring to FIG. 1, a speech-to-speech system is illustrated where an input signal in a first language is translated using rule-based models and statistical models into a second language. The system utilizes ASR, MT, and TTS components. There are I/O devices such as input audio devices (microphones) and output audio devices (speakers). Referring to FIG. 2, in addition to the hardware setup and the user interface (both graphical and voice), the essential components of the preferred embodiments of the present invention comprise of five basic components: (1) speech recognition; (2) machine translation; (3) N-best merging module; (4) verification; and (5) text-to-speech.

Though the speech recognition engine per se is not covered in this description, the recognition module is an integral part of the entire system. Two characteristics of this module are the N-best and multi-stream processing. Fundamentally, the minimum requirement for the ASR module is that it interprets an input signal into a string of text (equaling to 1^{st} best). Generally, ASR systems output not only the highest-confidence recognition but also lower-confidence results along with confidence scores. Some systems output a lattice of words with their associated confidence scores. With N-best or lattice output, the result can be further processed to achieve better recognition or processed in conjunction with the MT system to also achieve better translation accuracy. The S-MINDS system takes full advantage of N-best/lattice processing of the ASR as well as MT but also can operate in 1^{st} best mode.

The preferred embodiments of the present invention employ a multi-stream approach to ASR wherein multiple engines can be active at any one time. The advantage of allowing multiple engines is that strengths of different domains (or domain-sizes) can be leveraged. Traditionally ASR relies on either broad-domain statistical language models or narrow-domain statistical and/or grammar based non-statistical language models. Broad domains are useful when the domain of a recognition is uncertain. However, when the domain of a recognition is known, a recognizer can be trained on a very narrow domain, which improves recognition accuracy. The N-best lists from one or more ASR recognitions may be handled either separately or collectively to improve both recognition and translation results.

Machine translation can be performed via a hybrid system, which allows for both knowledge-based and statistical-based translation. The MT module is able to process a one-best output of an ASR engine up to the fill word lattice with associated confidence value output to arrive at the best recognition-translation pair for each method of MT.

The merge module is responsible for integrating the N-best outputs of the rule-based and statistical MT outputs along with confidence/translation scores to create a ranked list or recognition-translation pairs.

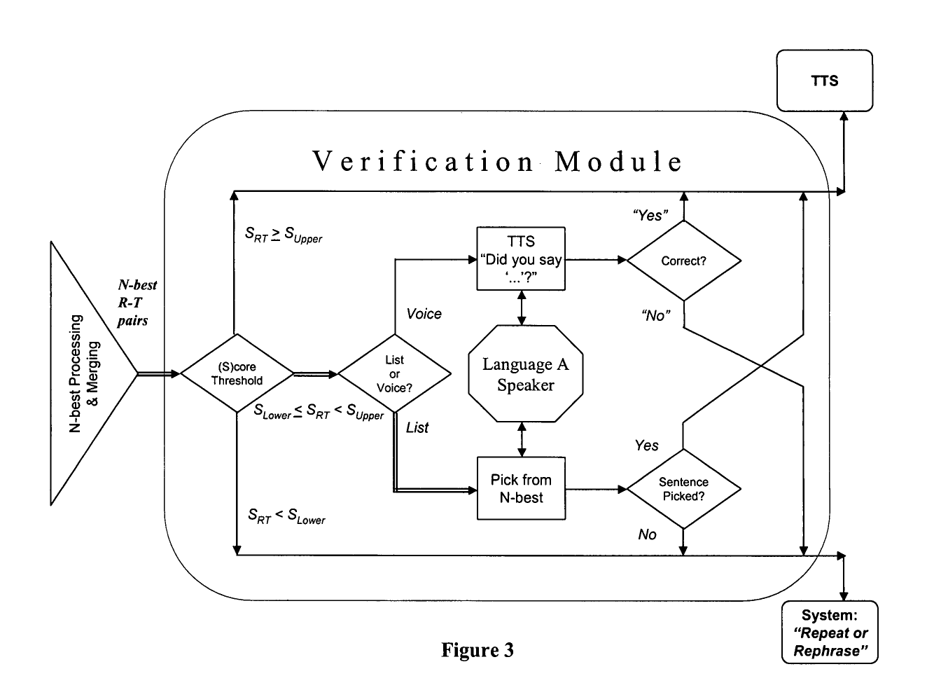

Referring to FIG. 3, the next module is verification. The preferred embodiments of the present invention give the option to put the human into the recognition loop thru either verbal or visual screen-based verification of recognized input. The output of the N-best “Processing and Merging” module is a list of N-best utterance/translation pairs where each pair has an associated score (S_{RT}). If S_{RT} of the highest score pair is below some lower threshold (S_{Lower}) the system prompts the speaker to either say the same sentence again or rephrase the sentence and the process will continue. If S_{RT} of the highest scoring pair is above some upper threshold (S_{Upper}), the translation is processed by the TTS module directly. If SRT falls between these thresholds (S_{Lower}<S_{RT}<S_{Upper}) the system requests the speaker to verify the utterance. In N-best or “list” verification mode, an N-best recognition list is displayed on the graphical interface. The speaker then must indicate either verbally or by selecting on the screen which utterance if any accurately reflects what was said. In the verbal verification mode), the system will ask the user “Did you say . . . ?” If speaker says “Yes,” the translation is processed by the TTS module. If, on the other hand, the user says “No,” the system prompts the user to either say the same sentence again or rephrase the sentence, and the process will continue. This is a key strength of the S-MINDS system in that a system developer can define the balance between precision and coverage, depending on the specific requirements of the situation to which it is applied, through the use of the supplied threshold ranges. A text-to-speech engine trained in each of the two languages under consideration is necessary to make the system complete.

S-MINDS can be ‘activated’ to listen for the next utterance in a variety of ways. The operator can push a button just before starting to speak. Alternatively, the operator can say “Translate” or another designated ‘Hot-word.’ A third mechanism is to have the system in a continuous mode in which it continues to listen for new utterances until the user interrupts the cycle (for example, by saying “Pause system”). Finally, for the most urgent communications (such as “Drop your weapon” and “Halt”), the user can simply utter a “Flash Command,” one of a limited set of expressions that can be translated whenever they are said because they are also ‘Hot-words.’

### I/O Devices

At the front end of the S-MINDS system is the input audio device which is responsible for receiving the voice signal. At the back end of the system is the audio output device, which is responsible for issuing system prompts or processing the output of the text-to-speech module. The physical configuration of the device is application-dependent. S-MINDS supports multiple input and multiple output devices, in both wired and wireless modes.

An example configuration in 1-way mode has the person using a headset, which contains an earpiece and receiver connected (via wires or wirelessly) to the CPU, and the output being a speaker. An example configuration of a 1.5-way system is with the interviewer using a headset as described above connected to the CPU (again wired or wirelessly) and the interviewee using a telephone handset-like receiver connected to the CPU via wires or wirelessly. An example 2-way configuration may have both persons using headsets connected to the CPU (wired or wirelessly).

### Speech Recognition

In the presently preferred embodiments of the present invention, S-MINDS, employ multi-stream recognition, wherein one or more recognizers are fed with the input sound signal. Multi-stream recognition allows the system to take advantage of the benefits of small to large-vocabulary recognition systems simultaneously.

The exact scope of each stream is determined empirically during the development cycle of the system. Generally, “small” vocabulary refers to ˜<1000 words, “medium” ˜<10,000 words, and “large” is considered 20,000+, although it is not thus limited. For example, multiple streams greater than three streams can be easily developed to provide further resolution. Or, domains with specialized vocabularies or speech can be employed as well.

The number of streams active at any one time is limited only by the platform on which S-MAIDS is implemented, but not by the system itself. The division or scope of each stream may be consistent with a hierarchical ontology built of the predicted rule-based machine translation system, described below, but this is not a requirement.

S-MINDS supports the implementation any of various third-party speech recognition engines, which are licensed components of the device. Depending on the specific requirements of the recognizer employed, the original sampling rate of the signal may be down-sampled to accommodate that recognizer.

Recognition is achieved by means that include but are not limited to the use of grammars and statistical language models; the exact mixture and weighting of the two are determined empirically.

In the context of recognition, a grammar is a token string that the recognizer uses to apply to the candidate text string in order to achieve better recognition. A grammar is a regular expression consisting of fillers, words, semantic classes, and other grammars all of which may be optional or required. A more complete explanation of grammars is provided in the translation section below.

Statistical language models (LM) measure the probability that a sequence of words (and/or semantic classes) would appear in “nature,” or specifically in the context of the training. They are based on in-domain data, which may be based on some or all the data available to the system but should be consistent with the domain of the recognition stream. The type of LM and parameters are limited only by the ASR engine itself and should be determined empirically to achieve the best recognition. The LM can avail itself to the semantic classes used in the rule-based recognition and translation to improve recognition by mitigating data sparseness issues.

There are numerous ways of building a statistical language model and optimizing their various parameters. The basic parameters are history (i.e. N-gram model), the back-off and smoothing models. Additionally the language models may consider only certain words (i.e. a skip language model) or be factored (Kirchhoff, 2002) where the model avails itself to different levels of abstraction, which becomes more useful under sparse data conditions. See Jelinek (1998) for a review of language modeling and associated parameters. In all cases the parameters need to be optimized for the particular engine.

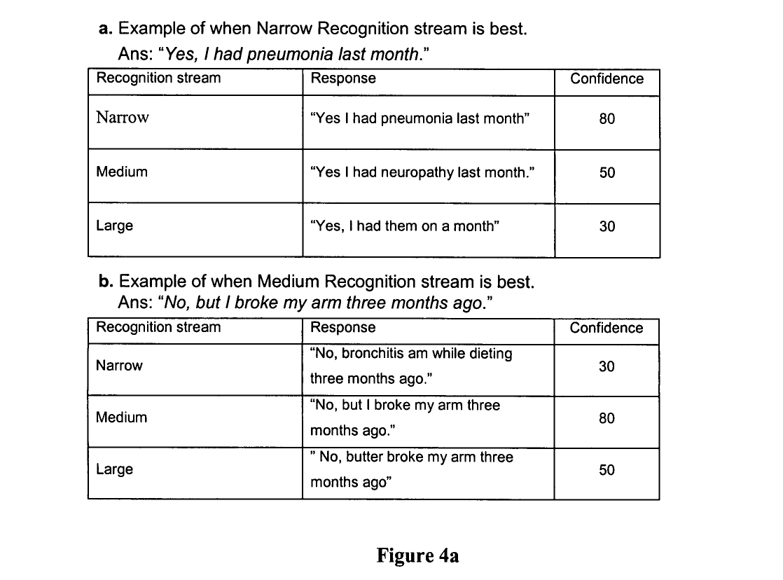

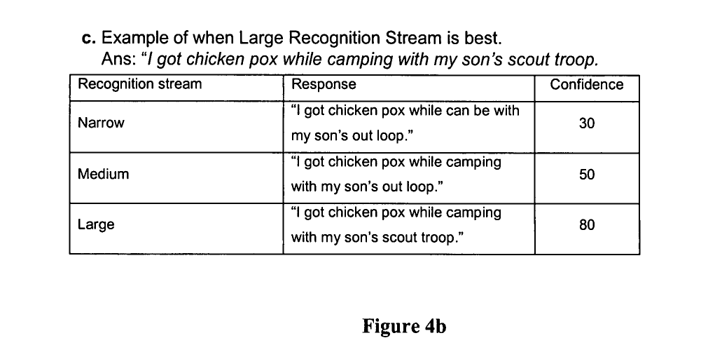

An example of how multiple-domain recognition might improve a system is illustrated in FIG. 4. In this example domains are divided into small, medium, and large as defined by the size of the training for the individual recognizers. The narrow-domain recognition is most accurate when the utterance is predicted by the recognizer (grammar+LM); this would be the case if grammars were built on exactly answers to the question: “Have you had any illnesses in the past year?” A medium-domain recognition is more accurate when the utterance is within the prediction of a larger training set; this would be the case if the grammars were built from everything relevant to doctor-patient interactions. An even larger-domain recognition would be most accurate if the utterance contains information not predicted in the realm of doctor-patient interactions. By taking these recognitions (1^{st}-best, N-best, or lattice) along with their associated confidence scores and weighted further by a translation quality metric, one is able to determine the highest quality recognition-translation pair.

### Mapping

Hierarchical ontologies of the recognition/translation grammars (all templates, questions, statements, answers, etc.) may be input into the recognition/translation system. The grammars should be grouped in a manner to best improve hierarchical recognition and therefore must be optimized to do so. For example, “how old is your son” and “how old is your daughter” can be classified together as “how old is your family-member” or even “how old is X.” The baseline for recognition/translation is a flat hierarchy and any deeper ontology must improve upon this. The grouping at all levels within the hierarchy may be achieved by manual or automatic means. There is no requirement that a node in the hierarchy have only one parent node, but the algorithm used to classify a recognized utterance to a level within the hierarchy may be negatively influenced by such ambiguous structures.

The purpose of creating a hierarchy is twofold. First, from the speech recognition point of view, it creates a natural division for grammar/language model training and thereby sets a logical division of the multi-stream approach to ASR described above.

Second, a hierarchy has the potential to improve mapping of an utterance to the appropriate grammar-based translation, by breaking the task into multiple steps. Finding the appropriate template for an input utterance is one of the basic tasks of rule-based translation, as it oftentimes occurs that multiple grammars can be applied to the same text string. Classifiers generally perform better when there are bigger distinctions between the groups of items they are classifying, and by breaking the task into multiple steps where items with similar features (see below for details of “features”) are grouped together, those distinctions will be maximized. In subsequent classifications in the hierarchy, those features which weighed heavily to distinguish one group from another, become less important and other features achieve attain higher discriminative power for distinguishing among members of the same group.

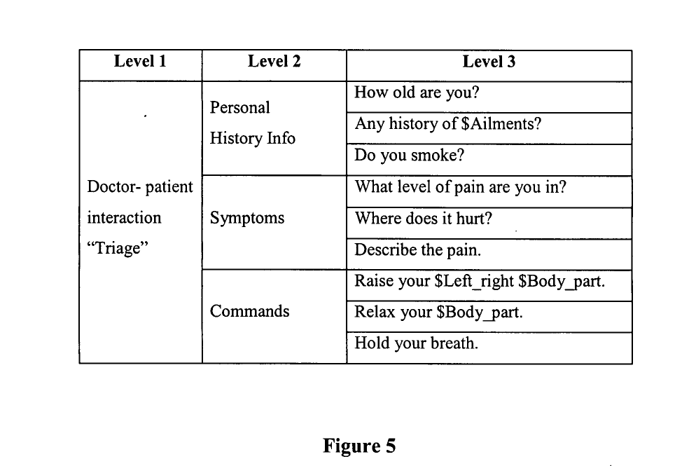

Consider, for example, doctor-patient interactions in FIG. 5. On the query side, there could be a four-level hierarchy. At the bottom of the hierarchy are the individual questions or statements that may be posed by the doctor. These questions may be grouped into larger subcategories, perhaps where all questions/statements dealing with medications are collected. At a higher level, all questions within the domain of patient triage are collected, and at the top of the hierarchy are all doctor-patient interactions. The answer training sets to these questions may be grouped in the same fashion, but this is not a requirement. In fact, it may be better to define the “answer” grammar hierarchy on grounds other than the “question” grammar hierarchy. For example, one may group questions about medications on the question side, one of which would be “When did you take the medication.” But on the answer side one may group together all answers related to time, in addition to answers to the previous, for example, answers to “When did you injure your $BodyPart?”

Classification of an input utterance into the hierarchy may be achieved by any classifier, including but not limited to Bayesian networks, neural networks, support-vector-machines, or singular-value-decomposition (SVD) vector mapping. The classifier is trained on each level within the N-level hierarchy between level 1 and level N not “inclusively.“

Classifiers may use but are not limited to the following features:
a. Words (with/out morphological stemming)
b. Parts-of-speech
c. N-grams
d. Semantic classes
e. Sentence vectors (linear combinations of SVD word vectors)

### Additionally these may be pared down or weighted according to a weighting scheme such as TF-IDF (term-frequency-inverse document frequency) or information gain.

Classifiers may be trained additionally on “recognized” speech. This means that the recognition errors are built into the training of the classifier, and therefore the system has the potential to make at least the classification stage more robust to recognition error.

### Translation

Machine translation is performed via a hybrid system, which allows for both rule-based and statistical MT. Therefore, a fundamental task of the system is to figure out whether an utterance should be translated via a grammar, translated via SMT, or rejected. If an utterance is handled by a rule-based system or is “predicted,” meaning there is some sort of template or canonical translation, paraphrase or not, built into the system, then the task is to map that utterance to the appropriate template. If an utterance is not directly predicted but can be translated through the use of statistical machine translation, then that must be determined. Finally if an utterance is neither predicted nor handled adequately by SMT, then it must be rejected. These three paths form the basis of the S-MINDS hybrid S2S translation system.

### Rule-Based Translation

When multiple rule-based approaches are implemented, the preferred embodiments of the present invention S-MINDS give the option to perform these in series or in parallel. The series method applies to an input recognition each rule-based approach sequentially in order of highest to lowest precision, with subsequent approaches as back-off algorithms. The parallel approach applies all rule-based approaches simultaneously; if any apply, the system selects the best recognition-translation based on a user-defined voting scheme.

Methods of rule-based recognition/translation include but are not limited to:
a. Exact match
b. (Semi-) Automatic template
c. Manual templates
d. Bag-of-word template

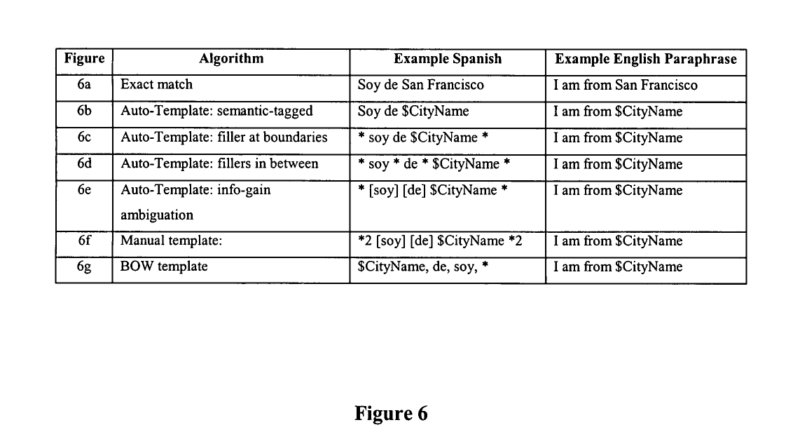

The exact match algorithm checks if a recognition matches word-for-word with an utterance upon which the system is trained. This has relatively low coverage and depends on the quality of the ASR and the size of the corpus on which the system is trained. However, since the translation is originally created by humans, the precision is very high. In FIG. 6, 6a illustrates such an example. Coverage will decrease due to recognition error. Precision may also suffer from this method when an utterance is misrecognized as something that is in the system. For example: Someone actually says “Soy de San Fernando,” but the ASR recognizes it as “Soy de San Francisco.”

Recognition-translation (R-T) templates to recognize and translate may be generated automatically and their translation based on a parallel corpus, or manually and the translation based on a human generated paraphrase translation.

Translation templates consist of the following fields:
A rule
A canonical text form (or back-translation)
A translation in the second language

A “rule” is a regular expression consisting of three types of tokens: words in the source language; operators which can show variations such as optional or alternative words; and references to other grammars, known as semantic classes (herein written as a token string pre-pended with a dollar sign, such as “$color”). A word in a rule is matched if and only if the word is identified in the speech input by the speech recognition engine. An operator is matched if and only if the variation that it represents is identified in the speech input by the speech recognition engine. For example, if brackets (“[” and “]”) indicate words that are optional, then the rule “how are you [doing]” would match the two phrases “how are you” and “how are you doing” in the speech input. A semantic class is matched when the rule for the semantic class is matched by the speech input by the speech recognition engine. For example, the grammar “$Number $StreetName” would be matched if and only if the rules for $Number and $StreetNane are matched in the speech input.

During the speech translation process, the speech recognition engine attempts to match the speech input against the currently active rules. The set of currently active rules is affected by three factors. The anticipated language of the next input can limit the active rules to those with rules in the anticipated language. The currently selected topic domain can limit the rules to those which are included in that domain (A topic domain is simply a collection of rules.) If the previously matched rule has restrictions that limit the rules of the next speech input, then only those rules allowed by the previous input are currently active. In another configuration, all of the rules could be active at all times with no restrictions.

Automatic templates may be based on the original parallel corpus, i.e. are simply abstractions of the “exact match” described above. A sentence in the training may be abstracted by tagging it with semantic tags already in the system, creating a “semantic-tagged-match” (see FIG. 6, 6a). This may further be abstracted by allowing fillers words or wild-cards (denoted by asterisks in the figure) at the sentence boundaries (FIG. 6, 6b) or in between words (FIG. 6, 6c). The fillers may be constrained to be of a specified length or even specified content. Additionally some words may be either made optional or completely abstracted as deemed with either manual supervision (semi-automatic) or by totally automatic means, such as part-of speech (i.e. articles) or information gain or TF-IDF score.

The more an automatic template abstracts and thereby increases coverage, the more susceptible it is to error. A semantic-tagged sentence match is simply one level of abstraction away from the exact match, but in addition to the errors of the exact match, it is prone to semantic-class confusion, where one member of a semantic class is misrecognized as another member. As fillers are allowed and words are abstracted or made optional, coverage increases and precision decreases. Heuristics (such as word order and word weight/TF-IDF) must be imposed to ensure the template and match criteria are sufficiently satisfied.

Templates can also be generated manually. This method requires no actual training data (in the form of monolingual or parallel corpus), and can be very useful for new domains and for languages with very little training resources. It is, however, very time intensive. Rule writing is facilitated through the use of S-MINDS rule writing tools called GramEdit, described in previously filed patent applications, the S-MINDS I patent, and GramDev.

In the bag-of-words/semantic-tags approach (see FIG. 6, 6g), the templates above are relaxed to allow reordering permutations of the templates. There are three methods to find the template which applies
a. Template match
b. Classifier match
c. SVD match

The template match is essentially what is described above. If the rule applies to an input sentence, then we have a match. In cases where more than one rule matches heuristics are required to decide which rule is best. For example, the winning template covers most of the input sentence words.

For classifier match, a classifier is trained on all the sentences that are covered by a given template. An input sentence is then classified to the highest-scoring template with the restriction, of course, that the template applies. Any classifier may be employed, for example Naive-Bayes classifiers, decision-trees, support-vector machines, etc.

For an SVD match we require a context matrix of words, phrases, and semantic tags, which is obtained from the training data, but not limited to it. This matrix is then reduced via a singular-valued-decomposition (SVD) into lower dimensional space (ref. Schütze 1998). A sentence vector is then created for each training sentence as well as the input test sentence. A sentence vector is a weighted linear combination of word, word part-of-speech, phrase, and/or semantic-tag vectors. The weighting of the vector may be based on TF-IDF or information gain or simply upon some heuristics, where for example, determiners (“the,” “a,” “an,” etc.) are weighed less heavily than nouns and verbs. A distance metric is then used to determine the closest template by either comparing a test vector to all the sentence vectors covered by a template or a cluster-center based thereupon. There are many different distance metrics possible, such as cosine, Hellinger, and Tanimoto. Again an input sentence is mapped to the “nearest” template provided that the template applies. The advantage of an SVD mapping is that input sentences, which contain synonymous words to those in templates, can be mapped to the correct template even though the actual words are different. If for example, the template in the doctor-patient interaction domain covered sentences, which had the word “surgery” but not “operation,” the SVD mapping would be able to correctly find the appropriate template because the vectors for “surgery” and “operation” point in similar directions.

The SMT engine is a modular component; therefore, any available SMT engine could be inserted in the preferred embodiments of the present invention. Ideally, the translation solution considers the matrix solution of ASR and the associated confidences, but is capable of using a 1st best or N-best solution as well. The SMT engine can be but is not limited to word- or phrase-based engines, which may or may not make use of semantic categories used in the rule-based recognition/translation to improve translation. A good summary of state-of-the-art SMT engines is given by Knight (1999).

As with the rule-based applications, S-MINDS offers series and parallel modes for SMT. In series mode, SMT acts as a back-off to the higher-precision rule-based alternatives. In parallel mode the SMT output competes with (or conversely can bolster) a rule-based output.

### N-Best Merging

The job of the merge module is to synthesize the output of the translation module, i.e. the multiple N-best recognition-translation (R-T) pairs. Along with each R-T pair is the associated recognition confidence and translation confidence scores. Based on these two scores, the merge algorithm ranks all pairs and produces an ordered list of R-T pairs.

The merge algorithm is optimized empirically and depends on:
a. ASR score (1^{st}-best, N-best, or lattice confidences)
b. RBMT score
c. SMT score

For ASR confidence values are based on the likelihood that an acoustic sequence produces a word sequence, which is based both upon an acoustic probability as well as a rule score, which includes both rule and language-model probabilities. The RBMT score contains mapping scores, from a classifier (i.e. SVD Hellinger distance) as well as any other value deemed to measure the precision of an applied template, including an algorithm's certainty and the number of words/classes that a template covers of the input sentence. SMT score is based on the Bayesian translation probability

argmax P(e|f)=argmax P(e) P(f|e)

which is based on a language model score of the target language P(e) and a translation model score P(f|e).

The actual algorithm to merge these scores is done via search of the solution space to find a maximum, or the parameters which achieve the highest-quality translation based upon a development set. This may be done by any number of optimization strategies, such as a Powell-search or simulated annealing.

### Thresholding & Verification

The N-best R-T list sorted by score (S_{RT}(i), where i=1→N) from the merge module is passed through a threshold. If the R-T score of the highest scoring pair (S_{RT}) is below an empirically determined lower bound (S_{Lower}), the utterance is rejected by the system and the system prompts the user to “Rephrase or Restate.” If S_{RT} is greater than an empirically determined upper bound (S_{Upper}), the translation is sent to the TTS module. If the S_{RT} falls between S_{Lower} and S_{Upper}, the utterance is verified. This brings the speaker into the loop to improve recognition. See FIG. 3 for a flowchart of the verification.

The system can operate in two modes: visual-verification or voice-verification. For visual verification, the top N (determined by the system developer, i.e. N=5) unique recognitions as measured by the R-T scores are presented on the UI for the speaker to select from (using mouse, touch screen, or verbally indicating which number). If a list item is selected, the translation is sent to the TTS module. If “None of the above” is selected, the system prompts the user to rephrase or restate.

In voice verification mode, the system verifies the top scoring R-T pair by asking the speaker, “Did you say: ‘ . . . ’? Say ‘yes’ or ‘no’.” If the person responds with “Yes,” the translation is sent to the TTS module. If the person responds with “No,” the system could prompt with another choice from the list or just ask the user to rephrase or restate.

In some situations, the goal of an S2S system is to have very high precision at the cost of lower coverage for example, in hospital situations where accuracy is critical; it is critical not to mistranslate “right leg” for “left leg.” In other situations, the threshold for translation error may be higher for example, at a hotel concierge, where mistranslations of “right” and “left” may lead one down the wrong path but are less likely to cause severe harm. The baseline relationship between precision and recall depends on the quality of the speech recognition, the amount of training data, the breadth of the domain, and other factors. As the system is improved over time with additional data, the interplay of precision and coverage will improve both, yielding a superior engine.

### Text-to-Speech

The text-to-speech module is a necessary component of the ASR system. Given an input text string, the TTS produces the speech output by a speaker device. This may be achieved by any of a number of methods including a TTS engine (like those from Cepstral or Nuance Corporation), or by splicing recordings.

### S-MINDS Interface

The S-MINDS user interface is multifaceted and customizable. It comprises multiple modes in both the graphical user interface (GUI) and the voice user interface (VUI). The GUI is made up of multiple panes which can be sized or positioned differently to customize for the user or situation. The possible panes are the Control Center, Topics, English Question Samples, Answer Samples, and Log. Above the layout of these panes are buttons that provide access to the various modes of usability as well as other features which will be discussed in more detail below.

In the presently preferred embodiment of the present invention, there are two custom user interfaces for healthcare and military settings, as well as a third interface used for development and testing of the system. Other custom interfaces can be quickly designed for any given user or situation.

The needs of a healthcare user require simplicity that will lead to speed of the interaction. A common setup for the healthcare interface includes the Control Center functions Hands-Free/Hands-On, 1-way/2-way, Loudspeaker On/Off, and Find Phrase.

The needs of military users also require simplicity and speed; however, military users have options for different functionality of the system. For example, the buttons in the Control Center enable control over Hands-Free/Hands-On, 1-way/2-way, and Find Phrase, but in addition to these, the buttons allow quick access to creating a text annotation (Text Note), a voice annotation (Voice Note), or showing an image (Show Image). The annotation features allow the operator to add non-interview information to the log. The image viewer allows the operator to show the interviewee a picture and edit the picture by making marks on it. The operator may then ask questions about the picture and save a copy of the picture in a way that associates it with the discussion.

This system can also have geo-spatial coordinates associated with locations on a map, so a mouse click on a map location can automatically be converted to a position which then can be saved in the log file or exported to a database. The actual location can be inputted in a number of different ways, including voice commands or mouse clicks.

Further customization for users or environment can be achieved through the matching of gender, ethnicity and politeness. The voice of S-MINDS can be matched to the gender and/or ethnicity of the operator or the interviewee. The system could also be configured so that the operator could switch voices based on the situation or people involved. It is also possible to show a picture of the persona of the system, such as a Hispanic doctor or an Arab soldier, in order to create confidence and solidarity between the system and the interviewee. In addition to the voice itself, the politeness level could also be customized for the situation. The operator could select different levels of politeness in which the translation will be played.

Modes of usability: S-MINDS has various modes of usability that can be activated in many combinations to provide ultimate customization for the user or situation. The system can be used Hands-on, Hands-Free, Eyes-Free, or Hands-Free & Eyes-Free, and has a wired configuration and a wireless configuration.

Hands-on is a mode allowing the user to start recognition or activate features using a keyboard, a mouse, or other peripherals (wired or wireless). For example, to start recognition, an English-speaking operator can click the button in the Control Center labeled ‘(F3) English’. They could also use a button (F3) on the keyboard, or push a designated button on a special peripheral device. Once recognition is activated, the user will hear a beep, and then they can speak a phrase which will be recognized and translated. Other features such as Find Phrase or Show Image are also accessed via the GUI or keyboard in Hands-on mode.

Once S-MINDS is in Hands-free mode, most usability controls and features can be controlled via voice commands. To start recognition, the English-speaking operator could say the Hot-word ‘Translate’ instead of using the on-screen GUI or peripherals.

Other features can be activated by the operator using a Hot-word or a Flash Command. A Hot-word is a word or short phrase that the system is programmed to listen for which, when recognized, activates system recognition. Hot-words can be programmed to be any word or short phrase such as ‘Translate’ or ‘Change system’. After the operator activates recognition using a Hot-word, they can say a phrase to be translated or they can give the system a command such as ‘2-way on’ or ‘show image’ which will activate a system feature.

In Hands-Free mode, the operator can also use Flash Commands. Flash Commands are phrases that are programmed to be recognized and translated without having to wait for recognition. These are usually short phrases that may be urgent in a particular situation such as ‘Stop’, ‘Don't shoot’, ‘Hold your breath’, or ‘Breathe now’. Instead of a user saying ‘Translate’, waiting for a beep, then saying ‘hold your breath’, the user can simply say ‘Hold your breath’, and the phrase will be translated right away. The set of Flash Commands can be customized for the domain. The use of Hot-words and Flash Commands allow access to almost all of S-MINDS features without requiring the use of the operator's hands.

Eyes-free mode is usually used in addition to Hands-Free mode when a user cannot see a screen or use a mouse, keyboard or peripherals. However, Eyes-Free mode can also be used in a wireless Hands-On environment. In a situation where the operator can see the screen, once the operator has spoken a phrase and it has been recognized, the operator can see that the correct phrase is being translated by looking at the screen; alternatively, S-MINDS can display a list of speech recognition results so the operator or second-language speaker can choose the best result for translation. In Eyes-Free mode, an English paraphrase of the recognized phrase will be played back to the operator through their headphones. This auto verification of English recognition allows the operator to verify that the correct phrase is being translated without having to look at the screen.

Using Hands-Free mode in addition to Eyes-Free mode allows the operator to conduct all interaction with S-MINDS via their headset and microphone. The operator can start recognition using the Hot-words, give Flash Commands, and activate other S-MINDS features via voice commands. The system can provide audible verification of what the operator said before translating it or while translating it. The operator can abort the outgoing translation with a voice command. S-MINDS can run in the background in Windows, so the operator can perform translation in Hands-free & Eyes-free mode while using other programs on the same computer.

Any of the above modes of usability can be used in a wired or wireless environment. Users can be in front of a desktop computer with wired or wireless peripherals, using a laptop in the field with wired or wireless peripherals, using a laptop with its base in a backpack while looking at a separate wireless screen, or even functioning completely Hands-Free/Eyes-Free, using all wireless peripherals to access a remote computer.

Once recognition has been activated, S-MINDS has various modes that allow the operator to determine when the interviewee will be prompted to respond. The first of these modes is 1-way. When the system is in 1-way mode, only the operator is prompted to speak. The operator may activate recognition and say a phrase to be translated, but the interviewee will not be prompted to respond.

In 2-way mode, after the operator's phrase has been translated, the system automatically toggles to recognize the interviewee, signaling them with a beep in their audio device. After the interviewee responds, the system is ready for the operator to begin another interaction.

If the operator does not want to have to re-initiate the 2-way interaction, they can use Rapid-Fire mode. In Rapid-Fire mode, once the operator begins the interaction, the system will toggle between the operator and interviewee, waiting for the operator to stop the interaction using a preset phrase such as ‘pause system’.

The operator can choose to play the outgoing translations through a loudspeaker (Loudspeaker on) or through the telephone handset (Loudspeaker off). When the operator switches to 1-way using a voice command, the loudspeaker turns on by default; when the operator switches to 2-way or Rapid-fire using a voice command, the loudspeaker turns off by default. The operator can change the loudspeaker setting, independent of other settings, by using the voice commands “Speaker on” and “Speaker off” or by clicking the Loudspeaker button in the Control Center.

S-MINDS has two modes which can be activated individually or separately to trigger a second response from the operator or interviewee. When neither of these modes is active, if the recognition confidence of a phrase falls below a customizable threshold, the phrase will not be translated and the user will hear a help message to guide them on their next utterance. If the confidence is above that threshold, the translation will play. If Repeat mode is on, when the recognition confidence falls below a customizable threshold, the user will be prompted to repeat their phrase. The number of times a user is prompted for repetition is also customizable. (See “Thresholding and Verification,” above, for further details).

The second mode, Verify Mode, can be used with or without Repeat Mode. Using Verify Mode, if the recognition confidence falls between the acceptance threshold and the rejection threshold, the user will be asked to verify their phrase. Verification can happen in two ways. If Eyes-Free mode is being used, the system will select the recognized phrase with the top score and play this phrase to the user through their audio device asking the user to verify if this was in fact the phrase they meant to say. The user can respond via voice with either ‘yes’ or ‘no’ in the given language. If Eyes-Free is not necessary, the system will output an n-best list of the top n recognition results and the user can select the correct one via the screen or keyboard. If Repeat Mode is active simultaneously, and the user rejects the recognition results, the user will be prompted to repeat their phrase. Similar to Repeat Mode, the number of times that a user will be verified and the thresholds involved are all customizable. (See “Thresholding and Verification,” above, for further details).

Organization of dialogue: Available dialogue is shown to the users via the Topics, English Question Samples, and Answer Samples panes. Users can navigate through the topics via the GUI or VUI. On screen, the user can click on a Topic to expand it and view the given Subtopics. Once a Subtopic is selected, the user can view the phrases associated to that Subtopic in the English Question Samples pane. The user can further examine possible dialogues by selecting a question, for which possible answer types will be show in the Answer Samples pane. This tree structure of Topics, Subtopics and phrases can also be accessed with voice commands. After recognition is activated with via VUI or GUI, the user can give a voice command to go to a Topic or Subtopic.

Search (Find Topic/Phrase): In addition to simply viewing the available dialogue through the internal organization, a user can also search for a Topic or Subtopic using Find Topic, or a Phrase using Find Phrase. Using the GUI, once either of these Find options is selected, a search window will open and the user can type in a keyword to search for. The results will be returned and if the user double-clicks on an entry, the system will either navigate to the selected Topic or Subtopic or play the selected Phrase.

This search function could also be activated via the VUI in a Hands-Free or Eyes-Free environment. After activating Find Topic or Find Phrase with a voice command, the user could say a keyword, and the system could either display the options on the screen or play the top N choices. The system could also be configured to play the Topics or Subtopics in which a key word was matched, and then the user would select the appropriate topic via voice and then search further through the phrases with another keyword.

Key phrases are short phrases that reference a longer phrase or set of phrases. When an operator commonly gives some kind of a long explanation to the interviewee, the operator may say only a Key Phrase which will be recognized by S-MINDS and the longer phrase will play for the interviewee. If this phrase or set of phrases is particularly long, a prompt will play for the operator to signal that the referenced phrase is finished.

S-MINDS is designed to give its users easy access to information gained in the interview. Thus, for each interview session, it generates a log folder containing audio recordings of all utterances, copies of images shown during the interview, and an HTML transcript of the interview. The HTML transcript has a text entry for each operator action and each utterance, displayed in chronological order. Next to each text entry is a hyperlink that the user can click to view the associated image or play the associated audio recording. For utterances (including voice memos spoken by the operator), the text fields are editable, so someone reviewing the log content can change transcriptions or translations based on the content of the recordings. The operator can start or end a log session at any time using a menu bar selection and can accept the default filename for each new log session (a date-and-time stamp) or enter a custom filename.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. A speech translation method, comprising the steps of:
receiving an input signal representative of speech in a first language;
recognizing said input signal with one or more speech recognition engines to generate one or more streams of recognized speech;
translating said streams of recognized speech, wherein each of the streams of recognized speech is translated using two or more translation engines; and
merging said translated streams of recognized speech to generate an output in a second language.

2. The speech translation method of claim 1, wherein each of the speech recognition engines uses a different domain.

3. The speech translation method of claim 1, wherein one of the translation engines is a rule-based translation engine.

4. The speech translation method of claim 1, wherein one of the translation engines is a statistical-based translation engine.

5. The speech translation method of claim 3, wherein one of the translation engines is a statistical-based translation engine.

6. The speech translation method of claim 1, wherein in the translating step, recognition-translation pairs are generated; and in the merging step, the recognition-translation pairs are ranked.

7. The speech translation method of claim 6, wherein associated with each recognition-translation pair is a recognition confidence score and a translation confidence score; and wherein each recognition-translation pair are ranked as a function of its recognition confidence score and translation confidence score.

8. The speech translation method of claim 1, wherein after the merging step, verifying the output.

9. The speech translation method of claim 8, wherein the verifying step is performed as a function of a threshold value.

10. The speech translation method of claim 8, wherein the verifying step is performed as a function of a lower threshold value, wherein if the output is below the lower threshold value, the speaker is requested to repeat or rephrase.

11. The speech translation method of claim 8, wherein the verifying step is performed as a function of an upper threshold value, wherein if the output is within a range with respect to the upper threshold value, verification with the speaker is performed.

12. The speech translation method of claim 8, wherein the verifying step is voice-based verification.

13. The speech translation method of claim 8, wherein the verifying step is visual-based verification.

14. The speech translation method of claim 1 wherein methods for user-interface are provided, including hot-words, flash-commands, gender/background matching, and politeness-level modulation.

15. A speech translation method, comprising the steps of:
receiving an input signal representative of speech in a first language;
recognizing said input signal with two or more speech recognition engines to generate two or more streams of recognized speech;
translating said streams of recognized speech; and
merging said translated streams of recognized speech to generate an output in a second language.

16. The speech translation method of claim 15, wherein each of the speech recognition engines uses a different domain.

17. The speech translation method of claim 15, wherein in the translating step, each of the streams of recognized speech is translated using two or more translation engines.

18. The speech translation method of claim 17, wherein one of the translation engines is a rule-based translation engine.

19. The speech translation method of claim 17, wherein one of the translation engines is a statistical-based translation engine.

20. The speech translation method of claim 18, wherein one of the translation engines is a statistical-based translation engine.

21. The speech translation method of claim 15, wherein in the translating step, recognition-translation pairs are generated; and in the merging step, the recognition-translation pairs are ranked.

22. The speech translation method of claim 21, wherein associated with each recognition-translation pair is a recognition confidence score and a translation confidence score; and wherein each recognition-translation pair are ranked as a function of its recognition confidence score and translation confidence score.

23. The speech translation method of claim 15, wherein after the merging step, verifying the output.

24. The speech translation method of claim 23, wherein the verifying step is performed as a function of a threshold value.

25. The speech translation method of claim 23, wherein the verifying step is performed as a function of a lower threshold value, wherein if the output is below the lower threshold value, the speaker is requested to repeat or rephrase.

26. The speech translation method of claim 23, wherein the verifying step is performed as a function of an upper threshold value, wherein if the output is within a range with respect to the upper threshold value, verification with the speaker is performed.

27. The speech translation method of claim 23, wherein the verifying step is voice-based verification.

28. The speech translation method of claim 23, wherein the verifying step is visual-based verification.

29. The speech translation method of claim 15 wherein methods for user-interface are provided, including hot-words, flash-commands, gender/background matching, and politeness-level modulation.
